(19) United States
(12) Patent Application Publication
(10) Pub. No.: US 2017/0228565 A1
(43) Pub. Date: Aug. 10, 2017

(54) POINT CALCULATION APPARATUS AND POINT CALCULATION METHOD

(71) Applicants: KABUSHIKI KAISHA TOSHIBA, Tokyo (JP); TOSHIBA TEC KABUSHIKI KAISHA, Tokyo (JP)

(72) Inventors: Kenta MORIZUMI, Shizuoka (JP); Fumiharu Nakayama, Kanagawa (JP)

(21) Appl. No.: 15/494,050

(22) Filed: Apr. 21, 2017

Related U.S. Application Data
(62) Division of application No. 14/145,793, filed on Dec. 31, 2013.

(30) Foreign Application Priority Data
Jul. 16, 2013 (JP) 2013-147502

(51) Int. Cl. G06K 7/00; H04N 1/00; G06K 15/14; G06K 15/00

(52) U.S. Cl. CPC G06K 7/0013; G06K 15/4065; H04N 1/00005; H04N 1/00037; H04N 1/00079; G06K 15/14; H04N 2201/0081; H04N 2201/0094

(57) ABSTRACT

An erasing apparatus according to an embodiment includes an erasing unit that erases an image formed on a sheet and a scanning unit that scans a surface of a sheet. A control determines whether or not an image on the sheet has been erased based on the scanned surface and count the number of sheets on which images are determined to have been erased, with respect to each size of the sheets. A network interface transmits information including the counted number of the sheets and a size of the sheets on which images are determined to have been erased to a managing apparatus that manages points associated with the erasing of the images on the sheets.

### CROSS -REFERENCE TO RELATED APPLICATIONS

This application is a division of U.S. patent application Ser. No. 14/145,793, filed on Dec. 31, 2013, which is based upon and claims the benefit of priority from Japanese Patent Application No. 2013 -147502, filed on Jul. 16, 2013 , the entire contents of each of which are incorporated herein by reference.

### FIELD

Embodiments described herein relate to a point calculation apparatus and a point calculation method for erasing an image printed on a sheet with a color erasable toner.

### BACKGROUND

Saving sheets for printing is one way to protect the environment and can be carried out in an office and the like. Sheets can be saved by decreasing frequency of printing. In addition, sheets can be saved by reusing a sheet by erasing an image printed on the sheet . Conventionally, in order for the sheet to be reusable, an image is formed on the sheet by an image forming apparatus such as a MFP (Multi Function Peripheral) with an erasable coloring agent such as an ink containing leuco dye, so that the image formed on the sheet can be erased by an erasing apparatus when the sheet having the image is no longer needed.

Since a color of the erasable coloring agent is decolorized when heated to a high temperature, the sheet is heated by the erasing apparatus to erase the image formed thereon to reuse the sheet. As stated above, erasing of the image formed on a sheet is hereinafter called as ‘color erasing’.

However, a level of environmental awareness of the customers may be different. Not all customers may not want to reuse the sheet after erasing the image on the sheet and rather want to use a new sheet instead, as the customer has to take time to erase the image for the sheet to be reusable.

### BRIEF DESCRIPTION OF THE DRAWINGS

FIG. 1 illustrates a system including an erasing apparatus according to an embodiment.

FIG. 2 is an example of a specific configuration of the erasing apparatus according to the embodiment.

FIG. 3 is a block diagram illustrating a control system of the erasing apparatus according to the embodiment.

FIG. 4 is a block diagram illustrating an example of management server according to an embodiment.

FIG. 5 is a diagram illustrating an example of points in an embodiment where the point is different depending on the size of sheet.

FIG. 6 is a flowchart illustrating a processing carried out in the management server according to the embodiment.

### DETAILED DESCRIPTION

In accordance with an embodiment, a method for managing points associated with erasing of images on sheets includes the steps of receiving information such as a number of sheets on which images have been erased, a size of the sheets on which images have been erased, and user data associated with the erasing of the images, calculating new points associated with a user based on the received information, calculating a total of points associated with the user based on the calculated new points and points previously associated with the user, and storing the calculated total point.

Embodiments of the present invention are described in detail below with reference to accompanying drawings, in each of which the same sign denotes the same unit.

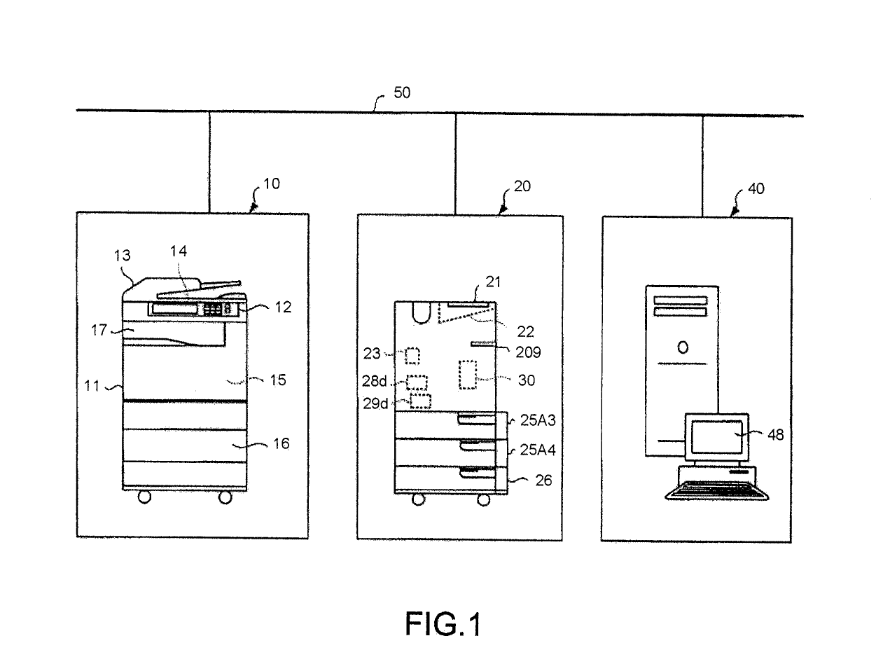

FIG. 1 illustrates a system including a point calculation apparatus (a management server) according to an embodiment. The network system shown in FIG. 1 comprises a digital multi function peripheral 10 (hereinafter referred to as a MFP: Multi Function Peripheral) serving as an image forming apparatus, an erasing apparatus 20 and a management server 40. The MFP 10, the erasing apparatus 20, and the management server 40 each have a data communication function and are all connected through a network 50 such as an LAN (Local Area Network). The network 50 may be a wireless communication network.

The MFP 10 has a scanner function, a printer function, and a network communication function. An operation panel 12, an ALF (automatic document feeder) 13, and a scanner (an image reading section) 14 are arranged in an upper portion of a main body 11 of the MFP. A printer (an image forming section) 15 is arranged in a center portion of the main body 11 and a sheet feed cassette 16 is arranged in a lower portion of the main body 11.

Using the operation panel 12, which comprises an operation section consisting of various keys and a touch panel type display section, a user inputs the number of copies, the number of printings, and the sheet size, and the like. The scanner section 14 reads a document fed by the ADF 13 or placed on a document table to generate image data.

The printer section 15 including a photoconductive drum and a laser irradiating unit processes image data read out by the scanner section 14 and image data created in a PC (Personal Computer) to fix an image on a sheet serving as a recording medium. The sheet on which an image is fixed by the printer section 15 is discharged to a sheet discharging section 17. The recording medium may be paper or an OHP sheet, and in the following description, the recording medium is described as a sheet.

The MFP 10 may carry out an image forming processing with an erasable coloring agent (which will be erased due to chemical reaction if heated to a given temperature) or an inerasable coloring agent (which will not be erased even if heated to the given temperature), and form an image with the erasable coloring agent when the sheet is to be reused. Further, a color erasable ink serving as the erasable coloring agent may be leuco dye or the like. The color erasable ink is erased when heated to, for example, about 180-200 degrees centigrade.

On the other hand, the erasing apparatus 20 comprises an operation panel 21, a sheet feed section 22, a scanner 23 serving as a reading section, a gate 28a, a reusability determination section 28d, a gate 29a, a sheet size determination section 29d, an erasing section 30, and a card reader-writer 209. A3 size sheet and A4 size sheet are set in the erasing apparatus 20.

Further, the erasing apparatus 20 comprises an A3 sheet storing tray 25A3 for storing A3 size sheet, an A4 sheet storing tray 25A4 for storing A4 size sheet and a second sheet storing tray 26 (reject box.). Reusable sheets are discharged to the A3 sheet storing tray 25A3 and the A4 sheet storing tray 25A4. The card reader-writer 209 issues a point card according to a customer ID, reads points recorded in the point card, and adds to the point card points obtained according to a size and the number of the sheets discharged to the A3 sheet storing tray 25A3 and the A4 sheet storing tray 25A4.

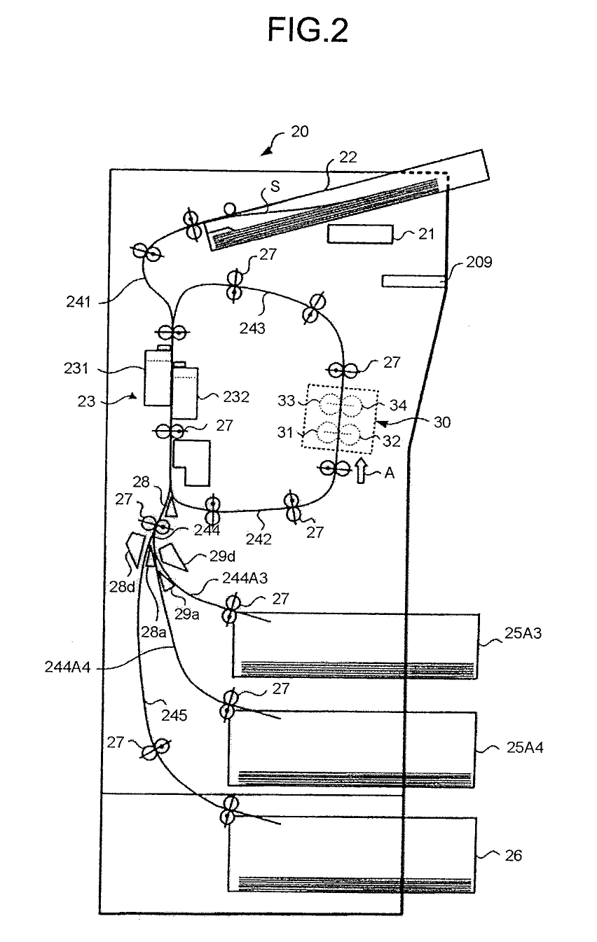

FIG. 2 illustrates a specific configuration of the erasing apparatus 20. In FIG. 2, the erasing apparatus 20 comprises the operation panel 21 including operation buttons and a display section, the sheet feed section 22, the scanner 23, and the erasing section 30. Moreover, the erasing apparatus 20 has first to fifth conveyance paths 241-245, the A3 sheet storing tray 25A3, the A4 sheet storing tray 25A4, and the second sheet storing tray 26 (reject box).

As shown in FIG. 2, along each of the conveyance paths 241-245, a plurality of conveyance rollers 27 is disposed to convey a sheet, each of which is driven by a motor. Further, a gate 28 is arranged to guide sheets to the conveyance path 242 or the conveyance path 244.

Along the first conveyance path 241 a sheet S is conveyed from the sheet feed section 22 to the scanner. Along the second conveyance path 242 the sheet S is conveyed from the scanner 23 to the erasing section 30 in a direction indicated by an arrow A. Along the third conveyance path 243 the sheet S is conveyed from the erasing section 30 to the scanner 23.

A gate 28a is a gate for guiding sheets based on the information whether or not the sheet is reusable. The reusability determination section 28d includes a sensor (not shown) and is arranged upstream along the conveyance direction with respect to the gate 28a.

The gate 29a, arranged downstream along the conveyance direction with respect to the gate 28a, guides renewable sheets according to the size of the sheets. The sheet size determination section 29d includes a sensor (not shown) and is arranged upstream along the conveyance direction with respect to the gate 28a. Sheets are detected by the reusability determination section 28d and guided by the gate 28a.

Along the fourth conveyance path 244, the sheet which is determined to be reusable by the reusability determination section 28d is conveyed. Along the fifth conveyance path 245, the sheet which is determined to be not-reusable by the reusability determination section 28d is conveyed.

The fourth conveyance path 244 is further divided into a conveyance path 244A3 and a conveyance path 244A4 according to the size of a sheet. That is, the gate 29a is controlled according to the detection result of the sheet size determination section 29d.

The scanner 23 comprises a first scanner 231 and a second scanner 232. The first scanner 231 is a scanner reading one side of a sheet, and the second scanner 232 is a scanner reading the other size of the sheet.

The erasing section 30 comprises a first erasing section including a heat roller 31 and a press roller 32 and a second erasing section including a press roller 33 and a heat roller 34. Sheets are conveyed between the heat roller 31 and the press roller 32 and between the press roller 33 and the heat roller 34 to be heated. The heat rollers 31 and 34 both include an internal heat source and a temperature detection section on the outside periphery. The heat source may be a lamp.

The erasing apparatus 20 shown in FIG. 2 substantially carries out the following erasing processing. First, in a case where the color erasing and reading mode of sheet is selected by the user with the operation section 21, a sheet S fed from the sheet feed section 22 is conveyed along the first conveyance path 241 to the scanner 23 serving as a reading section. The scanner 23 scans an image and reads out image data before the image on the sheet S is erased. Further, the toner coverage rate of the sheet S is calculated. The scanner 23 reads two sides of the sheet S with the first scanner 231 and the second scanner 232. Further, a print condition of the sheet S is determined based on the image read by the scanner 23.

A sheet S is determined to be non-reusable if the sheet S is determined to be damaged or crumpled according to the determined print condition and is guided to the fifth conveyance path 245 and then conveyed to the reject box 26. Further, a sheet of a high toner coverage rate, which is likely to curl when erased, is determined to be non-reusable and is then conveyed to the reject box 26. A sheet S without any damage or crumple is conveyed to the erasing section 30 through the second conveyance path 242.

The sheet S conveyed to the erasing section 30 is heated while passing through the erasing section 30 so that the image formed on the sheet S is erased by the heating. The erasing section 30 heats and pressurizes the sheet S at a high temperature of, for example, about 280-300 degrees centigrade so as to erase the image on the sheet S. That is, the image is formed on the sheet S with an erasable coloring agent which is erased when heated to a given temperature. Thus, the color of a sheet S can be decolorized by the sheet S being conveyed, at a preset conveyance speed, through the erasing section 30 which is heated at a given temperature.

The sheet S passing through the erasing section 30 is conveyed to the scanner 23 again through the third conveyance path 243. The scanner 23 reads a surface of the sheet S again to determine whether or not the image formed with the erasable coloring agent is successfully erased, and the sheet S is sorted based on the determination.

The sheet S—which is determined to be reusable by the reusability determination section 28d since the image formed on the sheet is determined to be erased according to the reading result of the scanner 23—is conveyed through the fourth conveyance path 244 as a sheet to be reused. Further, the sheet S—which is determined to be non-reusable by the reusability determination section 28d since the sheet is determined to be ripped or crumpled or there is a residual image formed with an inerasable coloring agent or a hand-drawn image left in the image area of the sheet according to the printing condition determined based on images read by the scanner 13—is conveyed to the reject box 26 through the fifth conveyance path 245.

As a result, a reusable A3 size sheet is conveyed to the A3 sheet storing tray 25A3, and a reusable A4 size sheet is conveyed to the A4 sheet storing tray 25A4. Generally, a sheet which is hardly reusable and is recycle of which is rejected is conveyed to the reject box 26.

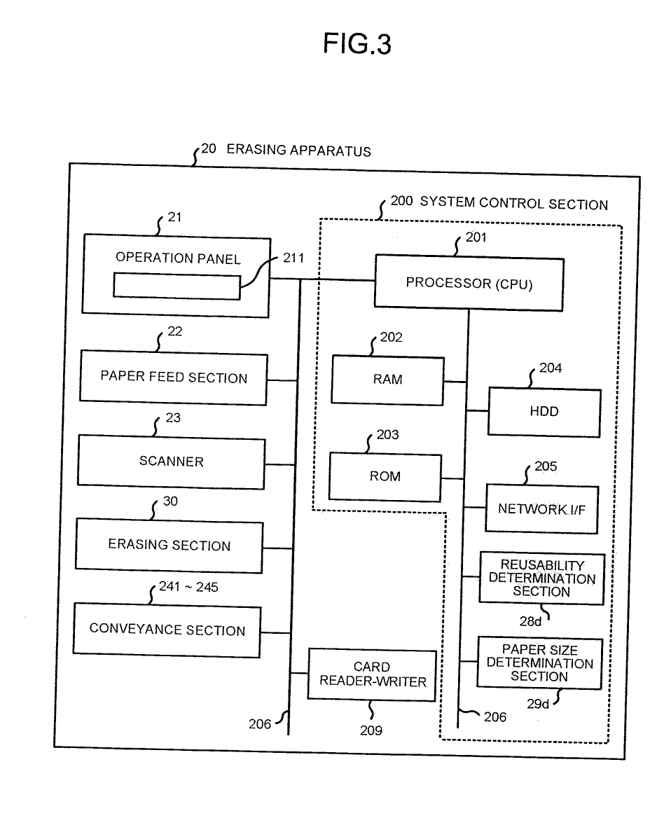

FIG. 3 is a block diagram illustrating a control system of the erasing apparatus 20, The erasing apparatus 20 includes a system control section 200 for controlling each section. In addition to the system control section 200, the erasing apparatus 20 further includes the operation panel 21, the sheet feed section 22, the scanner 23, the erasing section 30, a conveyance path 240 including the first to the fifth conveyance paths 241-245, and the card reader-writer 209.

The system control section 200 includes a CPU 201, a RAM (Random Access Memory) 202, a ROM (Read Only Memory) 203, an HDD (Hard Disc Drive) 204, a network interface (I/F) 205, the reusability determination section 28d, and the sheet size determination section 29d, which are all connected via a bus line 206.

The CPU 201 performs various processing functions by executing the control programs stored in the ROM 203. The RAM 202 is a main memory functioning as a working memory. The ROM 203 stores control programs and control data for controlling the operations of the erasing apparatus 20 and performing various processing functions. For example, the ROM 203 stores determination level information on whether or not to reuse a sheet or reject a sheet and the set temperature information of the erasing section 30. The CPU 201 classifies sheets into reusable sheets and non-reusable sheets according to the result of the image erasing by the erasing section 30.

Specifically, the CPU 201 controls the reusability determination section 28d and the sheet size determination section 29d to determine whether or not a sheet is reusable as well as the size of the sheet based on the determination level information related to reusability stored in the ROM 203 and size information indicating a size of the sheet (i.e., A3 size or A4 size). The sheet determined to be reusable is conveyed to the A3 sheet storing tray 25A3 or the A4 sheet storing tray 25A4, each corresponding to the size (A3 or A4) of the sheet. The CPU 201 counts the number of the sheets and stores the obtained number in the RAM 202. When the point card is inserted into the card reader-writer 209, the number of the reusable sheets corresponding to a customer ID with respect to each size, a corresponding additional point, and a total point with the additional point being added are stored in the RAM 202.

The HDD 204 is a high-capacity data storage memory capable of storing various kinds of information. The network interface (I/F) 205 is an interface communicating with the MFP 10, the management server 40, and other external apparatus (e.g. PC) via the local area network (LAN) 50.

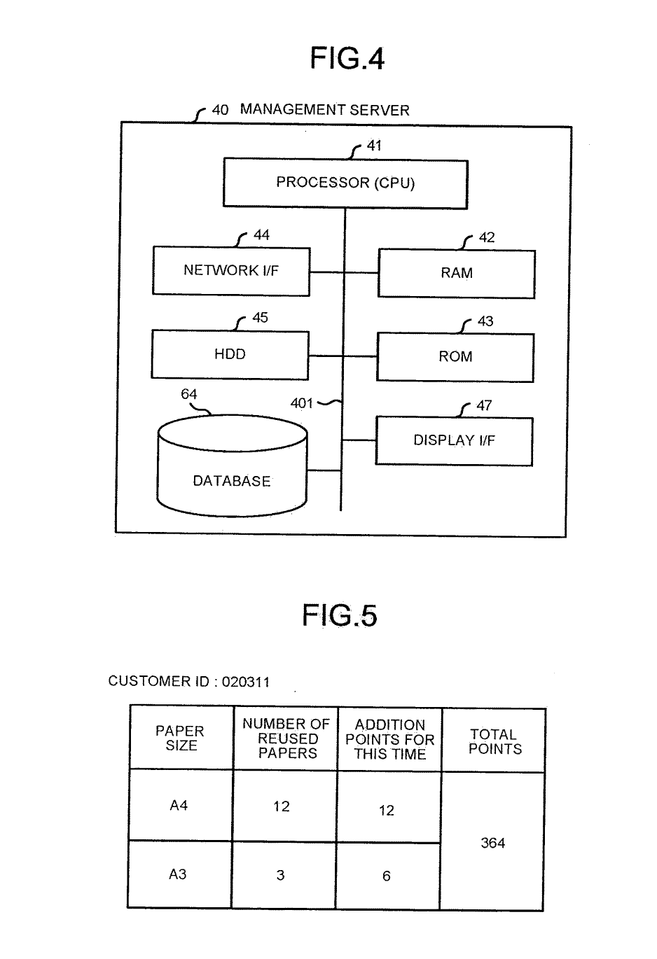

FIG. 4 is a block diagram illustrating functional sections included in the management server 40. The management server 40 comprises a CPU 41 serving as a controller, a RAM 42, a ROM 43, a network interface (I/F) 44, an HDD 45, a database 46, and a display I/F 47, which are all connected via a bus line 401.

The CPU 41 controls the whole management server 40. The CPU 41 further performs various processing functions, such as a point calculation function, by executing the programs stored in the ROM 43. The RAM 42 is a working memory. Control programs and control data for controlling basic operations of the server 40 are stored in the ROM 43.

The network interface 44—which is an interface for carrying out data communication with each apparatus (MFP 10, erasing apparatus 20, and the like) connected with the local area network (LAN) 50—includes an input section such as a keyboard and a mouse with which various data and commands can be input. The HDD 45 is a storage apparatus for storing data. Data for user authentication are stored in the HDD 45.

The CPU 41 in the management server 40 has a user authentication function. The user authentication function includes a function of acquiring user information such as a user ID or password input by a user with the operation panel 21 of the erasing apparatus 20. Further, when a user belongs to a specific department, the user authentication is carried out with respect to the department.

The user authentication function further includes a function of determining whether or not the user is authenticated by comparing the user information acquired from the MFP 10 or the erasing apparatus 20 with the data stored in the HDD 45 for user authentication. Further, the user information for the user authentication may also be read out by the MFP 10 or the erasing apparatus 20 from the point card belonging to the user.

Moreover, a conversion table for calculating the cost of securely disposing a sheet discharged by the erasing apparatus 20 to the reject box 26 is stored in the HDD 45, where, in one embodiment, the cost of securely disposing the sheet includes cost of using a shredder, cost of transporting the shredded paper, and any other service charges that may be incurred in connection with disposing of the shredded paper.

The CPU 41 communicates with the MFP 10 and the erasing apparatus 20 via the network I/F 44 to collect and calculate data relating to points sent from the erasing apparatus 20, adds points corresponding to each customer ID, and controls the database 46 to store calculated points. The display I/F 47 is an interface connected to the display.

The processor 41 of the management server 40 further controls a point calculation with the points sent from the erasing apparatus 20 corresponding to the number of sheets which are determined to be reusable.

That is, information of the size and the number of the sheets which are determined to be reusable after being erased is sent by the reusability determination section 28d and the sheet size determination section 29d in the system control section 200 of the erasing apparatus 20 via the network I/F 205. The processor 41 of the management server 40 controls the reusability determination section 28d and the sheet size determination section 29d, via the network I/F 44, to transmit point information including the number of reusable sheets with respect to each size. Then, the point information is temporarily stored in the RAM 42 to carry out the point calculation.

The calculated points are added to the current points stored in the database 64 in association with a customer ID, and then the points stored in the database 64 are updated.

FIG. 5 is a table illustrating the customer ID and the current point situation of a point card stored in the RAM 202 of the erasing apparatus 20. For example, 12 pieces of reusable A4 size sheet are discharged, and 3 pieces of A3 size sheet are discharged. Assuming that the point per A4 size sheet is 1 and the point per A3 size sheet is 2, then there are 12 points for A4 size sheet and 6 points for A3 size sheet. 18 points earned this time are added to the formerly-earned points and then the total points become, for example, 364. Point is determined based on the size of a sheet, the bigger the size of a sheet is, the more the points are.

The processor 41 controls the database 64 to store the total points earned. Then, total point information including the total points is sent to the erasing apparatus 20 via the network 44. The processor 201 of the erasing apparatus 20 receives the total point information via the network I/F 205 and writes the total point information in the card reader-writer 209.

In this way, addition points are added and then stored in a point card.

Further, the current situation of points is displayed on, for example, an operation panel provided in the erasing apparatus 20, or on the display 48 of the management server 40.

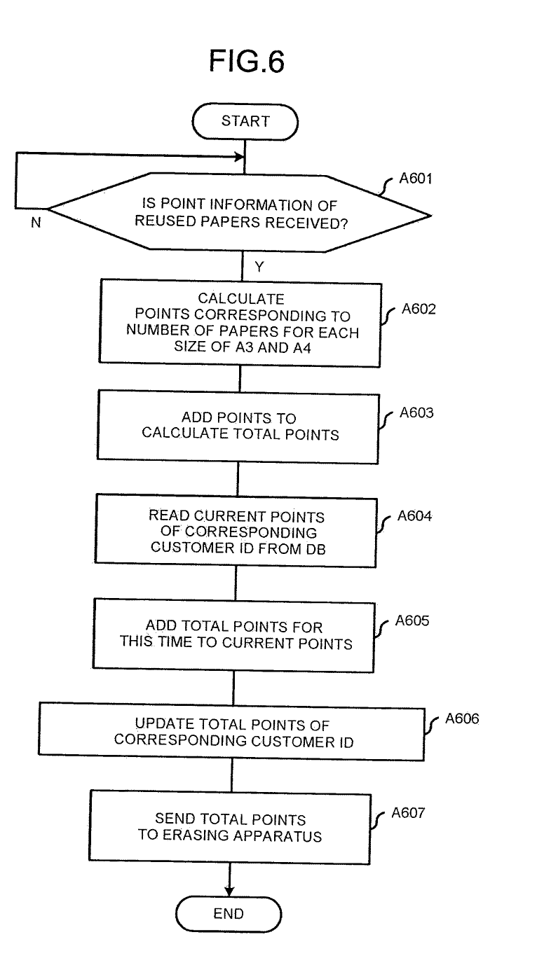

Next, the point calculation operation of the management server 40 of the embodiment is described below with reference to FIG. 6.

In the erasing apparatus 20, the size (A3 or A4) and the number of the reusable sheets are detected, and the point information is sent to the management server 40 together with the customer ID of the point card.

The CPU 41 of the management server 40 determines whether or not the information of the size and the number of the reusable sheets is received via the network I/F 44 (ACT A601). That is, the CPU 41 determines whether or not information relating to the reusable sheets is received.

If it is determined that the point information is received (YES in ACT A601), then the CPU 41 stores the point information in the RAM 42 temporarily and calculates the points with respect to each size of sheets by multiplying the point per sheet by the number of sheets (ACT A602).

Next, the CPU 41 adds the points corresponding to each size to calculate the total points acquired this time (ACT A603).

The CPU 41 retrieves information in the database 64 with reference to a customer ID as a keyword and reads the points that have been acquired corresponding to the customer ID (ACT A604). The points are temporarily stored in the RAM 42. The CPU 41 adds the aforementioned total acquired points to the points (ACT A605) .

The CPU 41 stores the obtained total points in a unit of the database 64 corresponding to the customer ID and updates the points that have been acquired as most recent total points (ACT A606).

The CPU 41 sends the most recent total points to the erasing apparatus 20 via the network I/F 44 (ACT A607).

On the other hand, the CPU 201 of the erasing apparatus 20 receives the most recent total points via the network 205 and visibly writes the total points on, for example, the surface of the point card inserted into the card reader-writer 209.

In this way, points can be accumulated in the point card by the erasing apparatus 20 for a user to shop or enjoy a service in the same shop.

As stated above, with the erasing apparatus described in the embodiment, a used sheet can be regenerated as a reusable sheet, thus, a customer can accumulate points in his/her own point card. As a result, the customer is motivated to use an erasable coloring agent for printing.

Further, the acquisition unit of acquiring information of the size and the number of the reusable sheets sent from the erasing apparatus is described in the embodiment; however, the present invention is not limited to this. For example, the reception of points from the erasing apparatus via the network I/F 44 is equivalent to an acquisition unit. In this case, the act of executing the point calculation unit is defined as the act of storing in a memory such as the RAM 42.

Further, the points earned by each customer are stored in, for example, the management server in the aforementioned embodiment.

In this case, the erasing apparatus comprises a point information sending and receiving unit which receives the point information resulting from a point calculation carried out after the information of a recording medium which is determined to be reusable since the image formed thereon is erased is sent to an external management server. Alternatively, the calculation may be carried out by the erasing apparatus, only the points that have been earned this time are sent to the management server which manages points, and the erasing apparatus may receive the total points that have been earned and writes the total points in the point card.

In this way, the range of point management is widened. For example, the points obtained by the erasing apparatus from a plurality of stores such as chain stores can be added up. It is more convenient for a customer if the points can be used when the customer shops in the stores. Besides, the customer will be motivated to use the erasing apparatus.

In the embodiment, the erasing apparatus grants points corresponding to the number of the reused sheets. The calculation of the points, even if it is achieved by a program, is covered by the present invention.

In the embodiment, the erasing apparatus and the image forming apparatus are separate apparatuses. However, a single apparatus performing a function of the erasing apparatus and a function of the image forming apparatus is also applicable to the present invention.

Further, in the aforementioned embodiment, points are calculated after the point information is sent to the management server from the erasing apparatus, but, it is not limited to this. Points may also be calculated in the erasing apparatus. That is, in this case, the erasing apparatus serves as a point calculation apparatus.

In the present embodiment, the functions for implementing the invention are recorded in the apparatus in advance, however, the present invention is not limited to this, the same functions may also be downloaded to the apparatus from a network or stored in a recording medium and then installed in the apparatus.

The form of the recording medium is not limited as long as the recording medium can store data like a CD-ROM and is readable by an apparatus . Further, the function achieved by an installed or downloaded program can also be achieved through the cooperation with an OS (Operating System) installed in the apparatus.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

1. An erasing apparatus comprising:
an input/output device configured to read a user ID from a medium provided by a user and output user data to the medium;
an erasing unit configured to erase an image formed on a sheet;
a scanning unit configured to scan a surface of a sheet;
a control unit configured to determine whether or not an image on the sheet has been erased based on the scanned surface and count the number of sheets on which images are determined to have been erased, with respect to each size of the sheets; and
a network interface configured to:
transmit information, including the user ID in association with the counted number of the sheets and a size of the sheets on which images are determined to have been erased, to a managing apparatus that manages user data associated with the erasing of the images on the sheets, and
receive, from the managing apparatus, updated user data corresponding to the user ID, the updated user data based on the transmitted information and user data previously stored in association with the user ID, wherein, after the updated user data is received, the input/output device outputs the updated user data to the medium.

2-3. (canceled)

4. The erasing apparatus according to claim 1, further comprising:
a display unit,
wherein the control unit is configured to control the display unit to display the updated user data.

5. (canceled)

6. The erasing apparatus according to claim 1, wherein the updated user data output to the medium represents points that the user can exchange for goods or services.

7. The erasing apparatus according to claim 6, wherein:
the control unit calculates a point value corresponding to the counted number of the sheets and a size of the sheets on which images are determined to have been erased, and
the information transmitted by the network interface includes the calculated point value.

8. The erasing apparatus according to claim 1, wherein the input/output device is a card reader/writer and the medium is a card.

9. The erasing apparatus according to claim 8, wherein the card reader/writer is configured to visibly write the user data on a surface of the card.

10. The erasing apparatus according to claim 9, wherein the card reader/writer visibly writes the user data on the surface of the card while the card is inserted into the card reader/writer.
